(19) United States
(12) Patent Application Publication
(10) Pub. No.: US 2017/0293246 A1
(43) Pub. Date: Oct. 12, 2017

(54) FIXING DEVICE AND IMAGE FORMING APPARATUS INCLUDING THE SAME

(71) Applicant: KYOCERA Document Solutions Inc., Osaka (JP)

(72) Inventors: Takeshi IKETANI, Osaka-shi (JP); Masaaki MARUTA, Osaka-shi (JP)

(73) Assignee: KYOCERA Document Solutions Inc., Osaka (JP)

(21) Appl. No.: 15/451,740

(22) Filed: Mar. 7, 2017

(30) Foreign Application Priority Data
Apr. 8, 2016 (JP) 2016-077890

(51) Int. Cl. G03G 15/20

(52) U.S. Cl. CPC G03G 15/2089

(57) ABSTRACT

A fixing device includes a fixing member, a pressuring member, a fixing frame, a supporting member and a biasing member. The fixing member and the pressuring member forms a fixing nip. The supporting member has a bearing part which rotatably supports the pressuring member. The biasing member biases the supporting member in a pressing direction in which the pressuring member is made to come into pressure contact with the fixing member. The supporting member has a fulcrum part and a contact part. The fulcrum part is disposed separately from the bearing part and turnably engaged with the fixing frame. The contact part is disposed on an opposite side to the fulcrum part with respect to the bearing part. The fixing frame has a restriction part. The restriction part comes into contact with the contact part to restrict the supporting member from being moved in the pressing direction.

### INCORPORATION BY REFERENCE

This application is based on and claims the benefit of priority from Japanese Patent application No. 2016-077890 filed on Apr. 8, 2016, which is incorporated by reference in its entirety.

### BACKGROUND

The present disclosure relates to a fixing device which fixes a toner image on the sheet and an image forming apparatus including the fixing device.

An electrophotographic type image forming apparatus includes a fixing device which fixes a toner image transferred on a sheet, such as a paper.

For instance, a fixing device having a heating body which is disposed inside of a cylindrical heat-resistant film and a pressuring roller which comes into pressure contact with the heating body via the film has been known. The pressuring roller of the fixing device comes into pressure contact with the film at a predetermined pressing force by a bearing means or a biasing means. The pressuring roller of the fixing device is formed by laminating a sponge layer on an outer circumferential face of a core metal.

### SUMMARY

In accordance with an aspect of the present disclosure, a fixing device includes a fixing member, a pressuring member, a supporting member and a pressing member. The fixing member is heated by a heat source. The pressuring member forms a fixing nip between the fixing member and the pressuring member. The fixing frame supports the fixing member so as to be rotatable. The supporting member has a bearing part which supports the pressuring member so as to be rotatable. The biasing member biases the supporting member in a pressing direction in which the pressuring member is made to come into pressure contact with the fixing member. The supporting member has a fulcrum part and a contact part. The fulcrum part is disposed separately from the bearing part on one side of the bearing part and engaged with the fixing frame so as to be turnable. The contact part is disposed on an opposite side to the fulcrum part with respect to the bearing part. The fixing frame has a restriction part. The restriction part comes into contact with the contact part to restrict the supporting member from being moved in the pressing direction.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view schematically showing an inner structure of a printer according to an embodiment of the present disclosure.

FIG. 2 is a sectional view showing a rear portion of the printer according to the embodiment of the present disclosure.

FIG. 3 is a perspective view showing a part of a fixing device according to an embodiment of the present disclosure.

FIG. 4 is a sectional view showing the fixing device (in a power ON state) according to the embodiment of the present disclosure.

FIG. 5 is a sectional view showing the fixing device (in a waiting state) according to the embodiment of the present disclosure.

FIG. 6 is a sectional view showing the fixing device (during a heating period) according to the embodiment of the present disclosure.

FIG. 7 is s aide view showing a pressing arm of the fixing device according to the embodiment of the present disclosure.

### DETAILED DESCRIPTION

Hereinafter, with reference to the attached drawings, a preferable embodiment of the present disclosure will be described. The following description is based on directions shown in each figure.

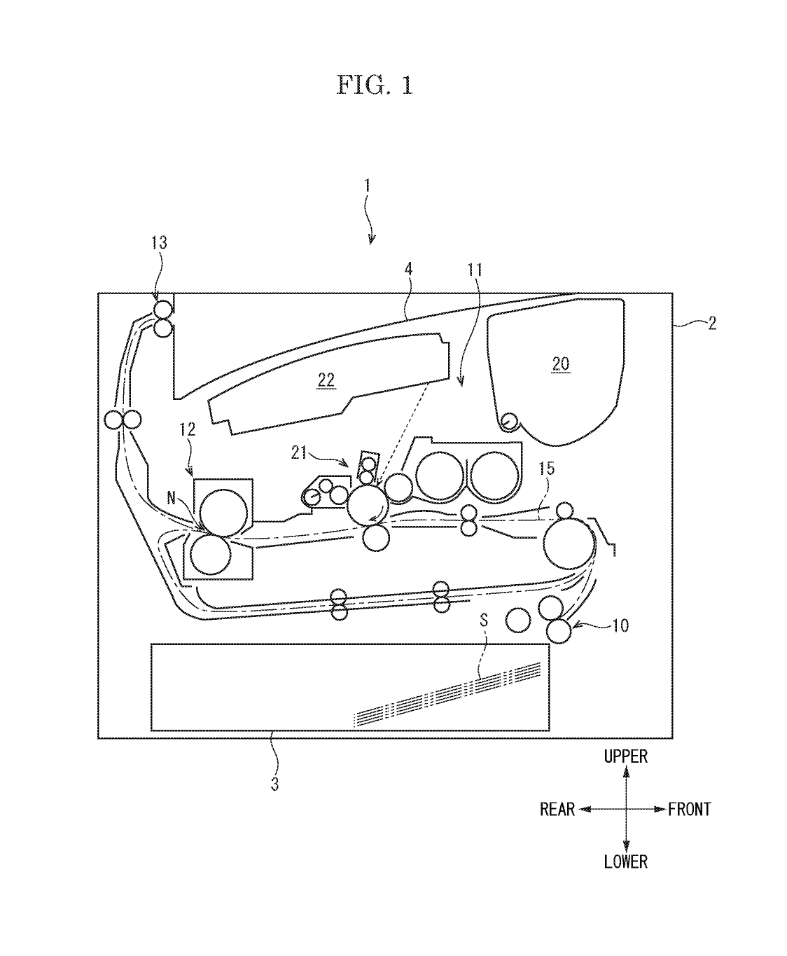

With reference to FIG. 1, a printer 1 as an image forming apparatus according to the embodiment will be described. FIG. 1 is a sectional view schematically showing an inner structure of the printer 1. In the following description, “an upstream”, “a downstream” and other similar descriptions respectively show “an upstream” side, “a downstream” side and other similar concept in a conveying direction in which a sheet S is conveyed.

The printer 1 includes an apparatus main body 2, a sheet feeding cassette 3 and an ejection tray 4. The sheet feeding cassette 3 is provided in a lower portion of the apparatus main body 2 and stores the sheets S (a bundle of sheets S). The ejection tray 4 is formed on an upper face of the apparatus main body 2.

The printer 1 further includes a sheet feeding part 10, an image forming part 11, a fixing device 12 and an ejecting part 13. The sheet feeding part 10 is disposed on an upstream side end portion of a conveying path 15 extending from the sheet feeding cassette 3 to the ejection tray 4. The sheet feeding part 10 feeds the sheet S stored in the sheet feeding cassette 3 to the conveying path 15 one by one. The image forming part 11 is disposed on a middle portion of the conveying path 15. The fixing device 12 is disposed on the conveying path 15 on the downstream side of the image forming part 11. The ejecting part 13 is disposed on a downstream side end portion of the conveying path 15.

The image forming part 11 has a drum unit 21 which forms a toner image using a black toner (a developer) supplied from a toner container 20. The drum unit 21 develops a latent image formed by being exposed from an optical scanning device 22 into the toner image. The image forming part 11 (the drum unit 21) transfers the toner image on the sheet S which is conveyed along the conveying path 15. The fixing device 12 fixes the toner image on the sheet S. The sheet S having the toner image is ejected by the ejecting part 13 to the ejection tray 4.

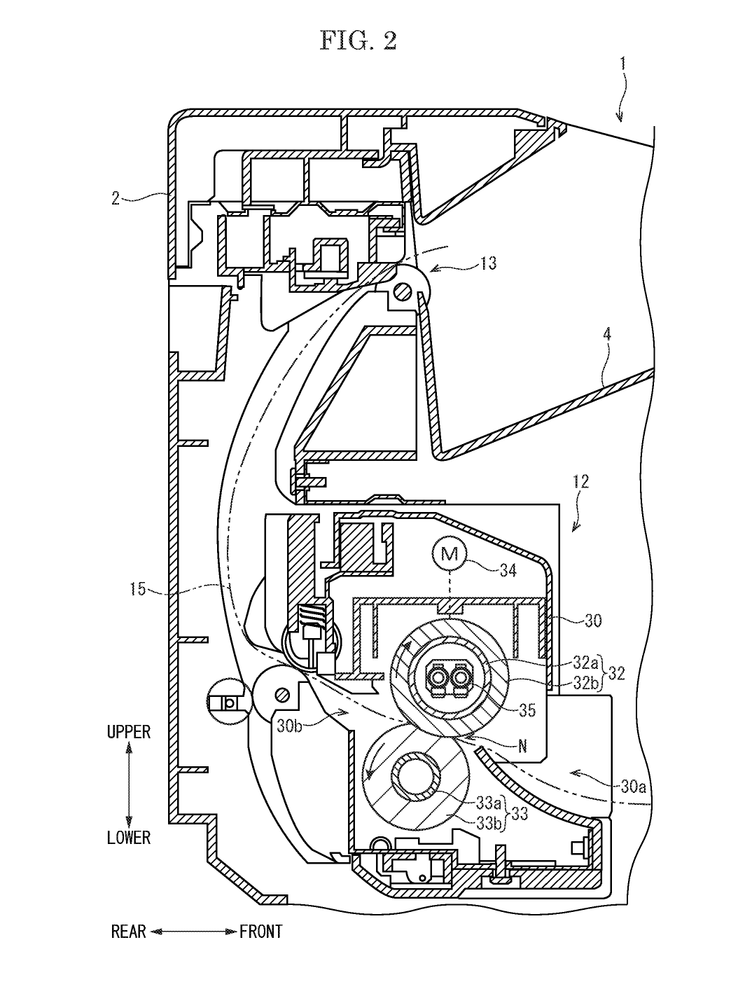

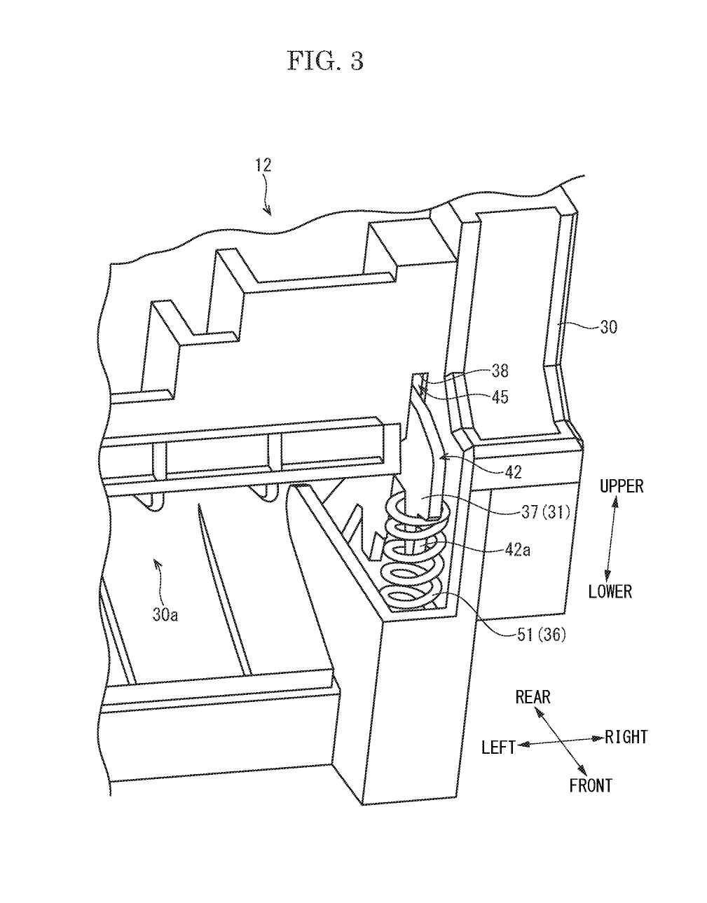

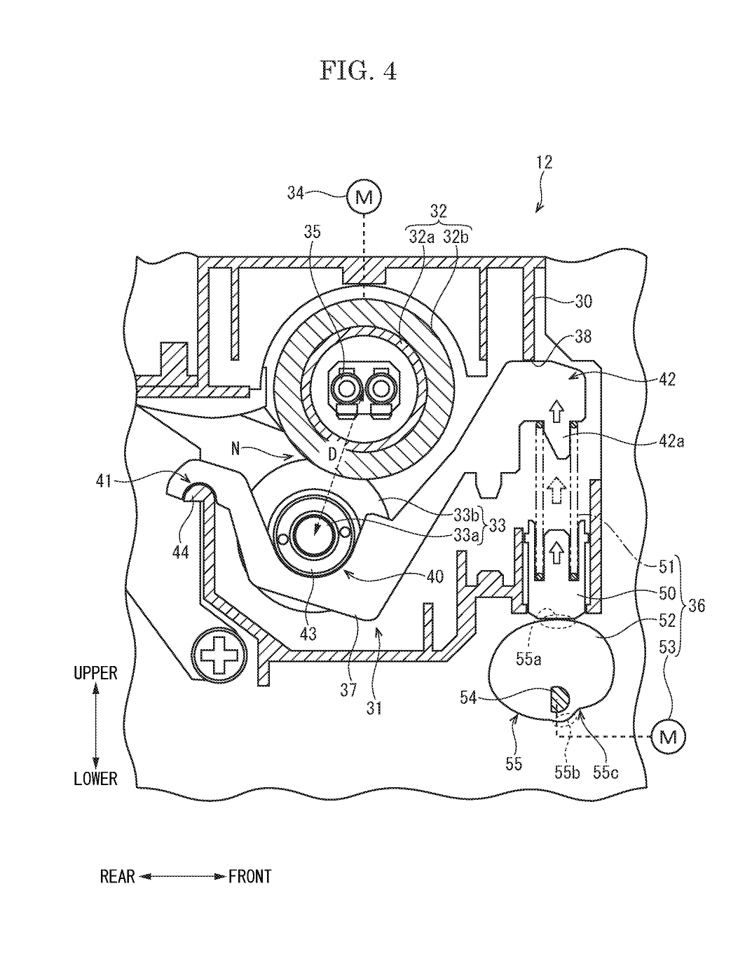

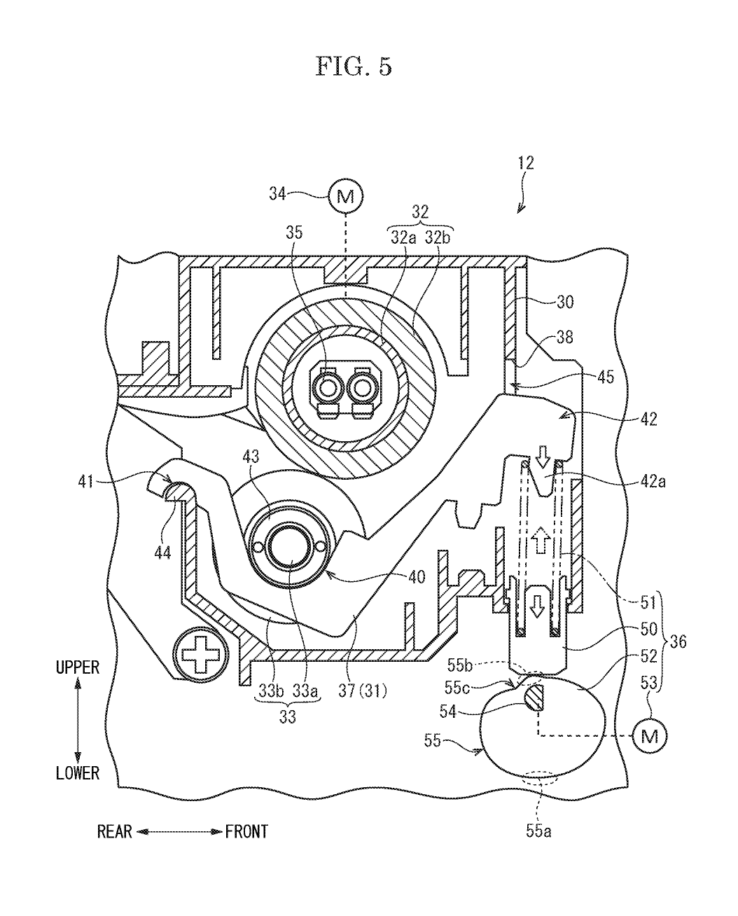

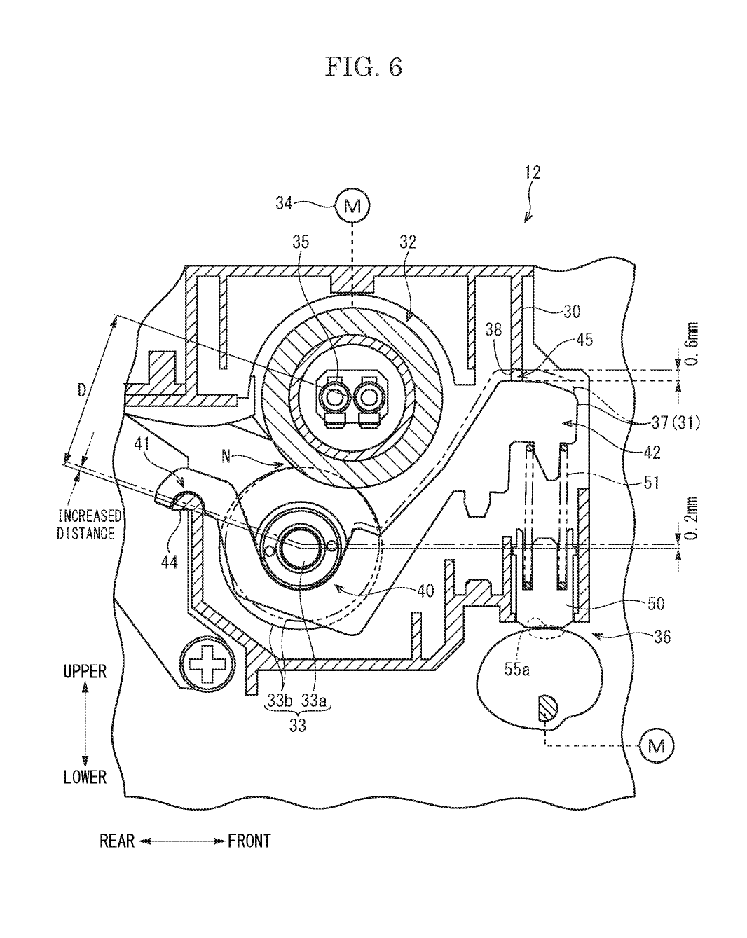

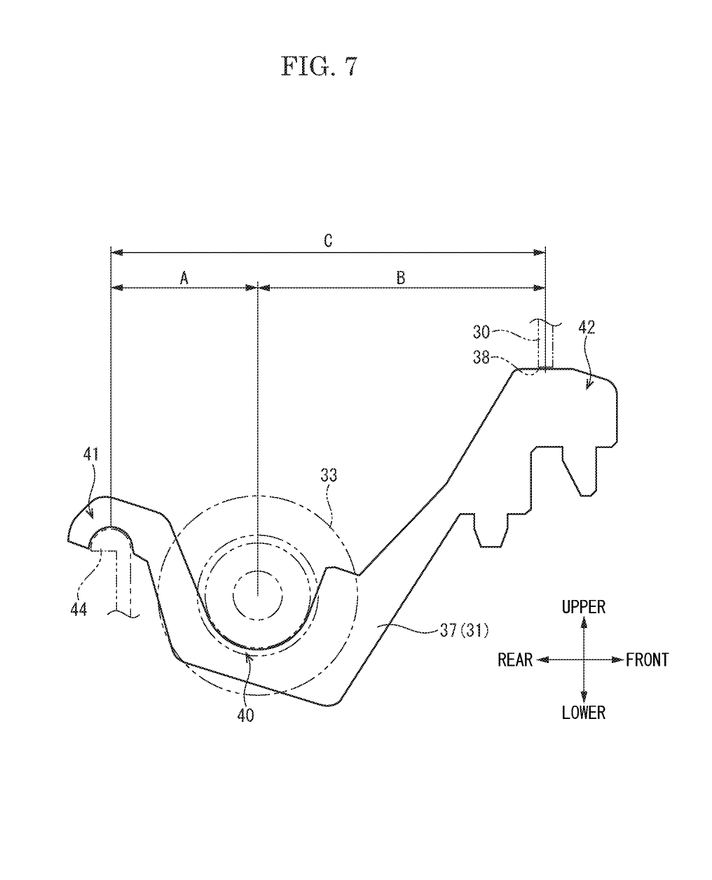

Next, with reference to FIG. 2 to FIG. 7, the fixing device 12 will be described. FIG. 2 is a sectional view showing a rear portion of the printer 1. FIG. 3 is a perspective view showing a part of the fixing device 12. FIG. 4 is a sectional view showing the fixing device 12 (in a power ON state). FIG. 5 is a sectional view showing the fixing device 12 (in a waiting state). FIG. 6 is a sectional view showing the fixing device 12 (during a heating period). FIG. 7 is a side view showing a pressing arm 37 of the fixing device 12.

As shown in FIG. 2 and FIG. 3, the fixing device 12 includes a fixing frame 30, a supporting frame 31, a fixing roller 32, a pressuring roller 33, a fixing motor 34, a heater 35 and a pressure changing part 36.

The fixing frame 30 is formed into a substantially box shape elongated in the left and right direction. The fixing frame 30 is fixed to an inside of the apparatus main body 2. The fixing frame 30 has a receiving port 30a and a discharge port 30b which are communicated with the inside of the apparatus main body 2. The receiving port 30a and the discharge port 30b form a part of the conveying path 15. The supporting frame 31 is provided so as to be turnable inside of the fixing frame 30 as described later in detail.

The fixing roller 32 as a fixing member is formed into a cylindrical shape elongated in the left and right direction. The fixing roller 32 is rotatably supported inside of the fixing frame 30. The fixing roller 32 is formed by laminating a releasing layer 32b (fluororesin or the like) on an outer circumferential face of a core material 32a made of metal (aluminum alloy, stainless steel, steel or the like).

The pressuring roller 33 as a pressuring member is formed into a cylindrical shape elongated in the left and right direction. The pressuring roller 33 is supported by the supporting frame 31 so as to be rotatable (refer to FIG. 4). The pressuring roller 33 comes into pressure contact with the fixing roller 32. Between the fixing roller 32 and the pressuring roller 33, a fixing nip N is formed. The pressuring roller 33 is formed by bonding an elastically deformable sponge layer 33b on an outer circumferential face of the core material 33a made of metal (aluminum alloy, stainless steel, iron or the like). The sponge layer 33b as a porous material is made of silicon rubber, for example, and has a plurality of fine cavities (air). The pressuring roller 33 may have a releasing layer (fluororesin) which covers the sponge layer 33b.

As shown in FIG. 2, the fixing motor 34 is connected to the fixing roller 32 via a gear train (not shown). The fixing motor 34 drives the fixing roller 32 to rotate it around an axis. The pressuring roller 33 is driven by the fixing roller 32 to be rotated in an opposing direction to a rotation direction of the fixing roller 32. The heater 35 as a heat source is a halogen heater or a ceramic heater, for example. The heater 35 is disposed in an inner space of the fixing roller 32. The heater 35 heats the fixing roller 32. The pressuring roller 33 is heated by the fixing roller 32 heated by the heater 35. The fixing motor 34 and the heater 35 are controlled by a control device (not shown) to be driven.

The fixing device 12 presses and heats the sheet S passing through the fixing nip N to fix the toner image on the sheet S (a fixing processing). In detail, the sheet S enters the inside of the fixing frame 30 through the receiving port 30a and passes through the fixing nip N with a toner image transferred face facing the fixing roller 32. The toner on the toner image transferred face is pressed and melt to be fixed on the sheet S. Then, the sheet S is discharged from the fixing frame 30 through the discharge port 30b. In the following description, a state where the heater 35 is driven is also called as “a heating state (a heating period)”, and a state where the heater 35 stops the driving (the rollers 32 and 33 are cooled) is also called as “a cooling state (a cooling period)”.

Here, with reference to FIG. 4, the supporting frame 31 as a supporting member will be described. The supporting frame 31 has a pair of left and right pressing arms 37 and a connecting frame (not shown) connected between the pair of left and right pressing arms 37. FIGS. 4 to 6 show the left pressing arm 37. Hereinafter, the left pressing arm 37 will be described.

The pressing arm 37 is formed into a substantially U-shape in a side view. In detail, the pressing arm 37 is formed into a substantially U-shape whose front side portion extends more upward than the rear side portion. Almost all of the pressing arm 37 is disposed inside of the fixing frame 30. A front end portion of the pressing arm 37 is exposed from a front face of the fixing frame 30.

The pressing arm 37 has a bearing part 40, a fulcrum part 41 and a contact part 42.

The bearing part 40 is formed on a middle portion of the pressing arm 37 in the front and rear direction. The bearing part 40 is formed into a recess opened to the upper side, in a side view. On the bearing part 40, a bearing 43 into which an axial end portion of the core material 33a of the pressuring roller 33 is fitted is fixedly attached. The bearing part 40 supports the pressuring roller 33 via the bearing 43 so as to be rotatable.

The fulcrum part 41 is formed on a rear end portion (one end portion) of the pressing arm 37. That is, the fulcrum part 41 is separated rearward (on one side) from the bearing part 40. The fulcrum part 41 is formed into a substantially semicircular recess opened to the lower side, in a side view. The fulcrum part 41 is slidably fitted to a fulcrum engagement part 44 formed in the fixing frame 30. That is, the fulcrum part 41 is engaged with the fixing frame 30 in a turnable state. The fulcrum engagement part 44 is formed into a substantially semicircular projection so as to correspond to the fulcrum part 41. The fulcrum part 41 and the fulcrum engagement part 44 are disposed below the fixing nip N.

The contact part 42 is formed on a front end portion (the other end portion) of the pressing arm 37. That is, the contact part 42 is provided on an opposite side to the fulcrum part 41 with respect to the bearing part 40. The contact part 42 is disposed above the fixing nip N. As shown in FIG. 3, the contact part 42 is exposed outside through a slit 45 formed in the front face of the fixing frame 30. The slits 45 are formed on both left and right end portions of the front face of the fixing frame 30 on both sides of the receiving opening 30a. The pair of left and right slits 45 are cut upward from a lower portion of the front face. When the pressing arm 37 is turned in the vertical direction around the fulcrum part 41, the contact part 42 is moved (turned) upward and downward along the slit 45 (refer to FIG. 4 and FIG. 5).

Next, with reference to FIG. 4 and FIG. 5, the pressure changing part 36 will be described. The pressure changing part 36 has a pair of left and right slide receiving part 50, a pair of left and right coil springs 51, a pair of left and right pressing cams 52 and a cam motor 53. FIGS. 4 and 5 show the left side elements of the pressure changing part 36.

Each slide receiving part 50 is formed into a substantially cylinder extending in the vertical direction. Each of the pair of left and right slide receiving parts 50 is provided at a lower rear portion of the fixing frame 30 so as to be slidable in the vertical direction.

Each coil spring 51 as a biasing member is interposed between the pressing arm 37 and the slide receiving part 50. An upper end portion of each coil spring 51 is fitted to a fitting projection 42a protruding from a lower face of the contact part 42. A lower end portion of each coil spring 51 is fitted into the slide receiving part 50. Each coil spring 51 biases the supporting frame 31 (the pressing arm 37) in a pressing direction in which the pressuring roller 33 is made to come into pressure contact with the fixing roller 32 (in an upper direction) (refer to a two-dot chain arrow in FIGS. 4 and 5).

The pair of left and right pressing cams 52 are fixed to a rotation shaft 54 extending in the left and right direction below the slide receiving part 50. The rotation shaft 54 is rotatably supported by the fixing frame 30, and connected to the cam motor 53 via a gear train (not shown). Each pressing cam 52 is a disk-shaped cam of which a distance between a rotation center (the rotation shaft 54) and its outer circumferential face (a cam face 55) is not constant. The cam face 55 of each pressing cam 52 comes into contact with a lower face of the slide receiving part 50. On the cam face 55, a pressing face portion 55a, a releasing face portion 55b and a recess portion 55c are set. A distance between the pressing face portion 55a and the rotation shaft 54 is longer than a distance between the releasing face portion 55b and the rotation shaft 54. The recess portion 55c is recessed near the releasing face portion 55b. The recess portion 55c is formed so as to have a smallest distance to the rotation shaft 54 among the portions of the cam face 55.

Here, an operation of the pressure changing part 36 will be described. The cam motor 53 is controlled by the control device (not shown) to rotate the rotation shaft 54 (each pressing cam 52) around an axis. Each pressing cam 52 is rotated with the cam face 55 coming into contact with the lower face of the slide receiving part 50. The pressure changing part 36 has a sensor (not shown) which detects a rotation angle of the rotation shaft 54 (each pressing cam 52). The control device receives a detection result of the sensor, calculates a position where the cam face 55 comes into contact with the lower face of the slide receiving part 50 and controls the cam motor 53.

In a state where a power source of the printer 1 is turned off (a power OFF state), each pressing cam 52 makes the recess portion 55c come (position) into pressure contact with the lower face of the slide receiving part 50 (the state is not shown). Under this state, because each slide receiving part 50 is moved to the lowermost, biasing force of each coil spring 51 becomes the weakest. In addition, each pressing arm 37 is turned to the lowermost, and the pressuring roller 33 is slightly separated from the fixing roller 32. That is, the fixing nip N is completely released. If a temperature sensor (not shown) of the fixing device 12 detects an abnormal excessive temperature during the heating period, each pressing cam 52 makes the recess portion 55c come into pressure contact with the lower face of the slide receiving part 50.

Next, for instance, a state where the power source of the printer 1 is turned on (a power ON state) will be described. As shown in FIG. 4, the cam motor 53 rotates the rotation shaft 54 to make the pressing force portion 55a of each pressing cam 52 come into contact with the lower face of the slide receiving part 50. When the pressing face portion 55a of each pressing cam 52 comes into contact with the lower face of the slide receiving part 50, each slide receiving part 50 is moves upward to compress each coil spring 51. Each pressing arm 37 is biased by each coil spring 51 to be turned upward around the fulcrum part 41. Then, the pressuring roller 33 supported by each pressing arm 37 is pressed to the fixing roller 32.

Each coil spring 51 biases the supporting frame 31 (each pressing arm 37) in the pressing direction (in the upper direction) on an opposite side to the fulcrum part 41 with respect to the bearing part 40. That is, each coil spring 51 biases the supporting frame 31 (each pressing arm 37) on a side of the contact part 42 which is a power point. Thereby, it becomes possible to make the pressuring roller 33 come into pressure contact to the fixing roller 32 with small biasing force.

Next, for instance, a state where the printer is turned to a waiting state (the power ON state, the cooling state) will be described. As shown in FIG. 5, the cam motor 53 rotates the rotation shaft 54 to make the releasing face portion 55b of each pressing cam 52 come into contact with the lower face of the slide receiving part 50. When each releasing portion 55b comes into contact with the lower face of the slide receiving part 50, each slide receiving part 50 is moved downward to release the compression of each coil spring 51. Then, each pressing arm 37 is turned downward around the fulcrum part 41. Thereby, the pressing force of the pressuring roller 33 to the fixing roller 32 is decreased so that the fixing nip N is released (in other ward, nip pressure is decreased).

As described above, the pressure changing part 36 adjusts the biasing force of each coil spring 51 to change pressure at the fixing nip N (the nip pressure). According to such a configuration, when the power source of the printer 1 is turned on, the pressure changing part 36 increases the nip pressure. On the other hand, when the power source of the printer 1 is turned off, the pressure changing part 36 decreases the nip pressure (releases the fixing nip N). The decreasing of the pressure at the fixing nip N can protect the fixing roller 32 and the pressuring roller 33.

By the way, the heater 35 indirectly heats the pressuring roller 33 via the fixing roller 32. When the fixing roller 32 is heated up to a temperature at which the fixing processing is enabled, a temperature of the pressuring roller 33 is also increased. Then, the air contained in the sponge layer 33b of the pressuring roller 33 expands to enlarge an outer diameter of the pressuring roller 33 (refer to a solid line in FIG. 6). As a result, a distance (hereinafter, also called as “a pitch distance D”) between a rotation center of the fixing roller 32 and a rotation center of the pressuring roller 33 is increased (refer to a dashed arrow in FIG. 6). The outer diameter and material of each of the rollers 32 and 33 are selected so as to form an appropriate fixing nip N in the heating state.

On the other hand, for instance, when the heater 35 is stopped (while the power source of the printer 1 is turned on), the temperature of the pressuring roller 33 is decreased as time is elapsed. That is, in the cooling state, the air contained in the sponge layer 33b of the pressuring roller 33 is contracted to make the outer diameter of the pressuring roller 33 small (the pitch distance D becomes narrow) (refer to a two-dot chain line in FIG. 6). If each coil spring 51 continuously biases the pressuring roller 33 to the fixing roller 32, apart of the outer circumferential face of the core material 33a of the pressuring roller 33 may be applied with stress. In this case, the sponge layer 33b may be peeled off from the core material 33a. Accordingly, the pitch distance D is preferably prevented from being shorter more than necessary. Then, the fixing device 12 of the embodiment is provided with a pair of left and right restriction parts 38 which inhibits the excessive shortening of the pitch distance D.

Prior to a description about each restriction part 38, a positional relationship between each of the parts 40 to 42 of the pressing arm 37 will be described. As described above, in the pressing arm 37, the fulcrum part 41, the bearing part 40 and the contact part 42 are formed in the order from the rear side to the front side. As shown in FIG. 7, each pressing arm 37 of the supporting frame 31 is formed such that a distance B between the bearing part 40 and the contact part 42 is longer than a distance A between the fulcrum part 41 and the bearing part 40. Accordingly, a distance C between the fulcrum part 41 and the contact part 42 is sufficiently longer than the distance A between the fulcrum part 41 and the bearing part 40.

As an example, in the embodiment, a ratio of the distance A to the distance B is set to 1:2. Accordingly, a ratio (a lever ratio) of the distance A to the distance C is set to 1:3. For example, when the pressing arm 37 is turned around the fulcrum part 41 (a fulcrum point) to displace the contact part 42 as a power point by 1.5 mm, the bearing part 40 as a working point is displaced by 0.5 mm.

Next, with reference to FIG. 3 and FIG. 6, each restriction part 38 will be described. Each of the pair of left and right restriction parts 38 is formed in an upper end portion (an upper face) of each slit 45 of the fixing frame 30. As shown in the two-dot chain line in FIG. 6, when the outer diameter of the pressuring roller 33 becomes small during the cooling period, each pressing arm 37 is turned upward around the fulcrum part 41. The contact part 42 of each pressing arm 37 is moved upward along the slit 45. Then, when an upper face of each contact part 42 comes into contact with each restriction part 38, the upward moving of the contact part 42 is stopped. Thereby, each pressing arm 37 (each bearing part 40) is prevented from being turned upward so that the pitch distance D is prevented from being shorter.

In the embodiment, a lever ratio of each pressing arm 37 is set to 1:3. Accordingly, for example, if a variable range (a shorting range) in the pitch distance D between at the heating period and at the cooling period is set to 0.2 mm, a distance between the upper face of each contact part 42 and each restriction part 38 is set to 0.6 mm (0.2 mm×3) (refer to FIG. 6).

In the fixing device 12 as described above, each restriction part 38 comes into contact with each contact part 42 to restrict the supporting frame 31 from being turned in the pressing direction (in the upper direction). According to such a configuration, because each restriction part 38 restrict the turning of each pressing arm 37, the pitch distance D is not shortened excessively. Thereby, for instance, if the outer diameter of the pressuring roller 33 becomes shorter during the cooling period, the pitch distance D can be prevented from being shortened excessively. The prevention of the excessive shortening of the pitch distance D prevents the outer circumferential face of the core material 33a from being applied with excessive stress. This can prevent the sponge layer 33b from being peeled off from the core material 33a.

In addition, according to the fixing device 12 as described above, the distance C between the fulcrum part 41 and the contact part 42 is set to be longer than the distance A between the fulcrum part 41 and the bearing part 40 sufficiently (two times or more) (refer to FIG. 7). The large lever ratio (A:C) allows a sufficiently larger displacement amount (a turning amount) of each contact part 42 than a displacement amount (a turning amount) of each bearing part 40. In the above example, due to the lever ratio of 1:3, the turning amount of each contact part 42 is three times of the turning amount of each bearing part 40. That is, a small turning amount of each bearing part 40 is amplified at each contact part 42 (refer to FIG. 6).

For example, a case where the variable range of the pitch distance D is set to 0.2 mm is assumed. If each bearing part 40 is made to come into contact with each restriction part, each restriction part is provided such that the turning amount of each bearing part 40 is 0.2 mm. In this case, the turning amount of each bearing part 40 is so small that each restriction part is formed with high positional accuracy. That is, it becomes difficult to position each restriction part. On the other hand, in the fixing device 12 of the embodiment, each restriction part 38 can be formed within a turning amount range (0.6 mm) of each contact part 42, the tuning amount range being amplified by using the principle of lever. Thereby, each restriction part 38 can be positioned easily, and it becomes possible to adjust a turning amount of each bearing part 40 (the pressuring roller 33) finely and easily. That is, a fine adjustment of the pitch distance D can be performed easily.

In the fixing device 12 of the embodiment, each pressing arm 37 is formed such that the distance B is longer than the distance A. However, the present disclosure is not limited to the embodiment. For instance, each pressing arm 37 maybe formed such that the distance A is equal to the distance B or the distance A is longer than the distance B. Alternatively, in the fixing device 12 of the embodiment, each pressing arm 37 is formed so as to have a lever ratio (A:C) of 1:3. However, the present disclosure is not limited to the embodiment, and it is only required to set the distance C to be longer than the distance A. IN addition, in the fixing device 12 of the embodiment, the variable range of the pitch distance D is set to 0.2 mm. However, the present disclosure is not limited to the value. The above lever ratio and the variable range of the pitch distance D are suitably set on the basis of the outer diameter and material of each of the rollers 32 and 33, the biasing force of the coil spring 51, the nip pressure or the like. Although it is preferable that the pitch distance D is constant, the variable range of the pitch distance D may be set in view of a dimension tolerance and an assembling tolerance of members.

In the fixing device 12 of the embodiment, the heater 35 is disposed in the inner space of the fixing roller 32. However, the present disclosure is not limited to the embodiment. For instance, an IH heater which generate magnetic field around the outer circumferential face of the fixing roller 32 may be used as the heat source.

Although each embodiment was described in a case where configurations of the disclosure are applied to the monochromatic printer 1 as an example, the configurations of the disclosure may be applied to a color printer, a copying machine, a facsimile, a multifunctional peripheral or the like, other than the monochromatic printer 1.

While the above embodiments has been described with reference to one embodiment of the fixing device and the image forming apparatus including the fixing device according to the present disclosure. A technical scope of the disclosure is not to be restricted by the above embodiments. The components in the above embodiments may be suitably replaced with other components, or variously combined with the other components. The claims are not restricted by the description of the embodiment of the disclosure as mentioned above.

1. A fixing device comprising:
a fixing member heated by a heat source;
a pressuring member which forms a fixing nip between the fixing member and the pressuring member;
a fixing frame which supports the fixing member so as to be rotatable;
a supporting member having a bearing part which supports the pressuring member so as to be rotatable; and
a biasing member which biases the supporting member in a pressing direction in which the pressuring member is made to come into pressure contact with the fixing member,
wherein the supporting member includes:
a fulcrum part disposed separately from the bearing part on one side of the bearing part and engaged with the fixing frame so as to be turnable, and
a contact part disposed on an opposite side to the fulcrum part with respect to the bearing part,
the fixing frame includes a restriction part which comes into contact with the contact part to restrict the supporting member from being moved in the pressing direction.

2. The fixing device according to claim 1,
wherein the pressuring member is formed by bonding an elastic deformable porous material on an outer circumferential face of a core material.

3. The fixing device according to claim 1,
wherein the supporting member is formed such that a distance between the bearing part and the contact part is longer than a distance between the fulcrum part and the bearing part.

4. The fixing device according to claim 2,
wherein the supporting member is formed such that a distance between the bearing part and the contact part is longer than a distance between the fulcrum part and the bearing part.

5. The fixing device according to claim 1,
wherein the biasing member biases the supporting member in the pressing direction on an opposite side to the fulcrum part with respect to the bearing part.

6. The fixing device according to claim 2,
wherein the biasing member biases the supporting member in the pressing direction on the opposite side to the fulcrum part with respect to the bearing part.

7. The fixing device according to claim 3,
wherein the biasing member biases the supporting member in the pressing direction on the opposite side to the fulcrum part with respect to the bearing part.

8. The fixing device according to claim 4,
wherein the biasing member biases the supporting member in the pressing direction on the opposite side to the fulcrum part with respect to the bearing part.

9. The fixing device according to claim 1, further comprising a pressure changing part which adjusts biasing force of the biasing member to change pressure at the fixing nip.

10. The fixing device according to claim 2, further comprising a pressure changing part which adjusts biasing force of the biasing member to change pressure at the fixing nip.

11. The fixing device according to claim 3, further comprising a pressure changing part which adjusts biasing force of the biasing member to change pressure at the fixing nip.

12. The fixing device according to claim 4, further comprising a pressure changing part which adjusts biasing force of the biasing member to change pressure at the fixing nip.

13. The fixing device according to claim 1,
wherein a distance between the fulcrum part and the contact part is longer than two times or more of a distance between the fulcrum part and the bearing part.

14. An image forming apparatus comprising:
an image forming part which transfer a toner image on a sheet; and
the fixing device according to claim 1, which fixes the toner image on the sheet.
